(19) United States
(12) Patent Application Publication
(10) Pub. No.: US 2026/0009975 A1
(43) Pub. Date: Jan. 8, 2026

(54) CAMERA OPTICAL LENS

(71) Applicant: AAC OPTICS (CHANGZHOU) CO., LTD., Changzhou (CN)

(72) Inventors: Qun Sun, Changzhou (CN); Shunda Zhou, Changzhou (CN)

(21) Appl. No.: 19/006,145

(22) Filed: Dec. 30, 2024

Related U.S. Application Data
(63) Continuation of application No. PCT/CN2024/103511, filed on Jul. 4, 2024.

(51) Int. Cl. G02B 9/64; G02B 13/00

(52) U.S. Cl. CPC G02B 9/64; G02B 13/0045

(57) ABSTRACT

The present disclosure discloses a camera optical lens. From an object-side to an-image side, the camera optical lens includes: a first lens having a negative refractive power; a second lens having a negative refractive power; a third lens having a positive refractive power; a fourth lens having a positive refractive power; a fifth lens having a positive refractive power; a sixth lens having a negative refractive power; wherein the camera lens satisfies the following conditions: 0.10≤d2/TTL≤0.20; 0.60≤f3/f4≤1.40; 0.01≤R7/R8≤0.30. The camera optical lens can achieve good optical performance.

### CROSS REFERENCE TO RELATED APPLICATIONS

The present application is a continuation of PCT Patent Application No. PCT/CN2024/103511, entitled “CAMERA OPTICAL LENS,” filed Jul. 4, 2024, which is incorporated by reference herein in its entirety.

### TECHNICAL FIELD

The present disclosure relates to the field of optical lens, in particular to a camera optical lens suitable for handheld devices, such as smart phones and digital cameras, and camera devices such as monitors, PC lens, and vehicle-mounted lens.

### BACKGROUND

With the rise of various smart devices in recent years, the demand for miniaturized camera optical lenses is increasing, and due to the reduction of the pixel size of light-sensitive devices, coupled with the development trend of electronic products with good functions, thin, lightweight, and portable appearance, miniaturized camera optical lenses with good imaging quality have become the mainstream of the current market. In order to obtain a better image quality, a multi-piece lens structure is mostly equipped. Moreover, with the development of technology and the increase of diversified needs of users, the pixel area of light-sensitive devices is constantly shrinking, and the requirements of the system for imaging quality are constantly improving, a camera optical lens with six lenses gradually appears in the lens design. There is an urgent need for camera optical lenses with good optical performance.

### SUMMARY

In response to the foregoing technical problems, an object of embodiments of the present disclosure is to provide a camera optical lens, which can have good optical performance.

To resolve the foregoing technical problems, the present disclosure provides a camera optical lens, comprising, from an object side to an image side in sequence being: a first lens having a negative refractive power; a second lens having a negative refractive power; a third lens having a positive refractive power; a fourth lens having a positive refractive power; a fifth lens having a positive refractive power; a sixth lens having a negative refractive power; wherein the camera lens satisfies the following conditions: 0.10≤d2/TTL≤0.20; 0.60≤f3/f4≤1.40; 0.01≤R7/R8≤0.30; where, d2 represents a distance on axis between an image side surface of the first lens and an object side surface of the second lens; TTL represents a total track length of the camera optical lens; f3 represents a focal length of the third lens; f4 represents a focal length of the fourth lens; R7 represents a central curvature radius of the object side surface of the fourth lens; R8 represents a central curvature radius of the image side surface of the fourth lens.

As an improvement, wherein the camera optical lens further satisfies the following conditions: 1.80≤(R1+R2)/(R1−R2)≤6.30; where, R1 represents a central curvature radius of the object side surface of the first lens; R2 represents a central curvature radius of the image side surface of the first lens.

As an improvement, wherein the fifth lens is provided glued to the sixth lens.

As an improvement, wherein the camera optical lens further satisfies the following conditions: v5−v6≥35.00; where, v5 represents an abbe number of the fifth lens; v6 represents an abbe number of the sixth lens.

As an improvement, wherein the camera optical lens further satisfies the following conditions: 5.00≤TTL/f≤7.00; where, f represents a focal length of the camera optical lens.

As an improvement, wherein an object side surface of the first lens is convex in a paraxial region, an image side surface of the first lens is concave in a paraxial region; and the camera optical lens further satisfies the following conditions: −6.21≤f1/f≤−0.97;0.01≤d1/TTL≤0.10; where, f represents a focal length of the camera optical lens; f1 represents a focal length of the first lens; d1 represents a thickness on-axis of the first lens.

As an improvement, wherein an object side surface of the second lens is concave in a paraxial region, an image side surface of the second lens is convex in a paraxial region; and the camera optical lens further satisfies the following conditions: −21.11≤f2/f≤−3.75; −9.81≤(R3+R4)/(R−R4)≤<−2.45; 0.06≤d3/TTL≤0.26; where, f represents a focal length of the camera optical lens; f2 represents a focal length of the second lens; R3 represents a central curvature radius of the object side surface of the second lens; R4 represents a central curvature radius of the image side surface of the second lens; d3 represents a thickness on-axis of the second lens.

As an improvement, wherein an object side surface of the third lens is convex in a paraxial region, an image side surface of the third lens is convex in a paraxial region; and the camera optical lens further satisfies the following conditions: 1.18≤f3/f≤5.80; −1.96≤(R5+R6)/(R5−R6)≤−0.31; 0.02≤d5/TTL≤0.26; where, f represents a focal length of the camera optical lens; R5 represents a central curvature radius of the object side surface of the third lens; R6 represents a central curvature radius of the image side surface of the third lens; d5 represents a thickness on-axis of the third lens.

As an improvement, wherein an object side surface of the fourth lens is convex in a paraxial region, an image side surface of the fourth lens is concave in a paraxial region; and the camera optical lens further satisfies the following conditions: 1.29≤f4/f≤5.84; −3.71≤(R7+R8)/(R7−R8)≤−0.68; 0.07≤d7/TTL≤0.26; where, f represents a focal length of the camera optical lens; d7 represents a thickness on-axis of the fourth lens.

As an improvement, wherein an object side surface of the fifth lens is convex in a paraxial region, an image side surface of the fifth lens is convex in a paraxial region; and the camera optical lens further satisfies the following conditions: 0.56≤f5/f≤2.34; 0.13≤(R9+R10)/(R9−R10)≤0.50; 0.05≤d9/TTL≤0.18; where, f represents a focal length of the camera optical lens; f5 represents a focal length of the fifth lens; R9 represents a central curvature radius of the object side surface of the fifth lens; R10 represents a central curvature radius of the image side surface of the fifth lens; d9 represents a thickness on-axis of the fifth lens.

As an improvement, wherein an object side surface of the sixth lens is concave in a paraxial region, an image side surface of the sixth lens is convex in a paraxial region; and the camera optical lens further satisfies the following conditions: −4.36≤f6/f≤−0.83; −3.71≤(R11+R12)/(R11−R12)≤−0.72; 0.03≤d11/TTL≤0.13; where, f represents a focal length of the camera optical lens; f6 represents a focal length of the sixth lens; R11 represents a central curvature radius of the object side surface of the sixth lens; R12 represents a central curvature radius of the image side surface of the sixth lens; d11 represents a thickness on-axis of the sixth lens.

As an improvement, wherein the first lens is made of glass material; the second lens is made of glass material; the third lens is made of glass material; the fourth lens is made of glass material; the fifth lens is made of glass material; the sixth lens is made of glass material.

The beneficial effect of the present disclosure are as follows. The camera optical lens designed according to the present disclosure has excellent optical characteristics, and the camera optical lens has good optical performance. The camera optical lens is particularly suitable for in-vehicle lenses and WEB camera lenses, which includes camera elements such as CCD (Charge-Coupled Device), CMOS (Complementary Metal-Oxide-Semiconductor) and other camera elements for high pixels.

### BRIEF DESCRIPTION OF THE DRAWINGS

In order to more clearly illustrate the technical solutions in the embodiments of the present disclosure, the accompanying drawings to be used in the description in the embodiments will be briefly introduced hereinafter, and the following is a brief introduction of the drawings required in the description of the embodiments. It is obvious that the accompanying drawings in the description hereinafter are only some of the embodiments of the present disclosure, and that for a person having ordinary skill in the art, other accompanying drawings can also be obtained according to these drawings without creative labor.

FIG. 1 is a schematic diagram of a camera optical lens in accordance with a first embodiment of the present disclosure;

FIG. 2 shows the longitudinal aberration of the camera optical lens shown in FIG. 1;

FIG. 3 shows the lateral color of the camera optical lens shown in FIG. 1;

FIG. 4 presents a schematic diagram of the field curvature and distortion of the camera optical lens shown in FIG. 1;

FIG. 5 is a schematic diagram of t a camera optical lens in accordance with a second embodiment of the present disclosure;

FIG. 6 shows the longitudinal aberration of the camera optical lens shown in FIG. 5;

FIG. 7 shows the lateral color of the camera optical lens shown in in FIG. 5;

FIG. 8 presents a schematic diagram of the field curvature and distortion of the camera optical lens shown in FIG. 5;

FIG. 9 is a schematic diagram of a camera optical lens in accordance with a third embodiment of the present disclosure;

FIG. 10 shows the longitudinal aberration of the camera optical lens shown in FIG. 9;

FIG. 11 shows the lateral color of the camera optical lens shown in in FIG. 9;

FIG. 12 presents a schematic diagram of the field curvature and distortion of the camera optical lens shown in FIG. 9;

FIG. 13 is a schematic diagram of a camera optical lens in accordance with a fourth embodiment of the present disclosure;

FIG. 14 shows the longitudinal aberration of the camera optical lens shown in FIG. 13;

FIG. 15 shows the lateral color of the camera optical lens shown in FIG. 13;

FIG. 16 presents a schematic diagram of the field curvature and distortion of the camera optical lens shown in FIG. 13;

FIG. 17 is a schematic diagram of a camera optical lens in accordance with a fifth embodiment of the present disclosure;

FIG. 18 shows the longitudinal aberration of the camera optical lens shown in FIG. 17;

FIG. 19 shows the lateral color of the camera optical lens shown in FIG. 17;

FIG. 20 presents a schematic diagram of the field curvature and distortion of the camera optical lens shown in FIG. 17;

FIG. 21 is a schematic diagram of a camera optical lens in accordance with a sixth embodiment of the present disclosure;

FIG. 22 shows the longitudinal aberration of the camera optical lens shown in FIG. 21;

FIG. 23 shows the lateral color of the camera optical lens shown in FIG. 21;

FIG. 24 presents a schematic diagram of the field curvature and distortion of the camera optical lens shown in FIG. 21.

FIG. 25 is a schematic diagram of a camera optical lens in accordance with a comparative embodiment of the present disclosure;

FIG. 26 shows the longitudinal aberration of the camera optical lens shown in FIG. 25;

FIG. 27 shows the lateral color of the camera optical lens shown in FIG. 25;

FIG. 28 presents a schematic diagram of the field curvature and distortion of the camera optical lens shown in FIG. 25.

### DETAILED DESCRIPTION OF THE EMBODIMENTS

To make the technical problems to be solved, technical solutions and beneficial effects of the present disclosure more apparent, the present disclosure is described in further detail together with the figure and the embodiments. It should be understood the specific embodiments described hereby is only to explain the present disclosure, not intended to limit the disclosure. It is understandable to a person having ordinary skill in the art that, in various embodiments of the disclosure, many technical details are proposed to enable the reader to better understand the present disclosure. However, even without the technical details and various variations and modifications based on the following embodiments, the technical solution claimed to be protected by the present disclosure can be realized.

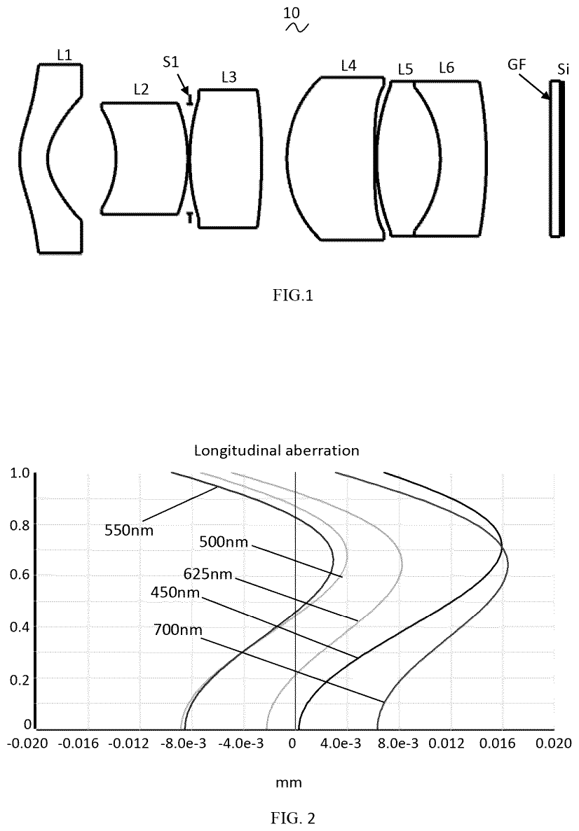

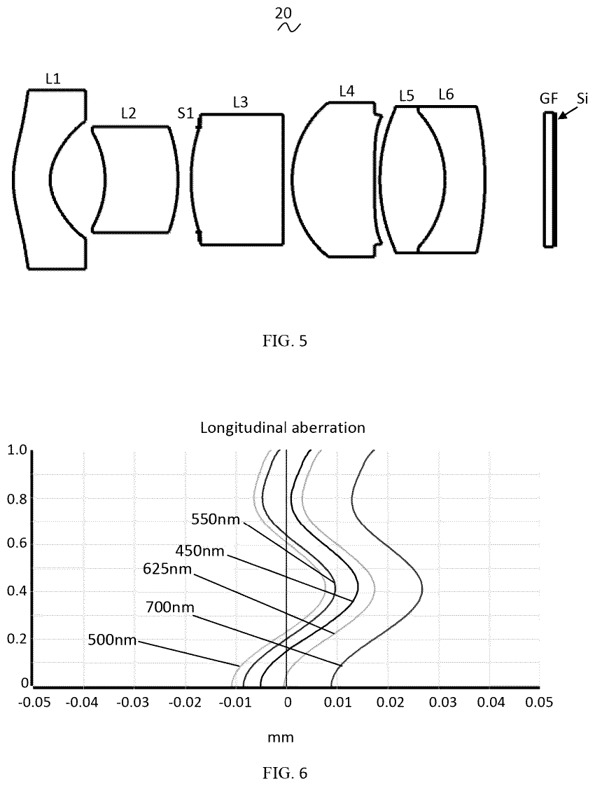

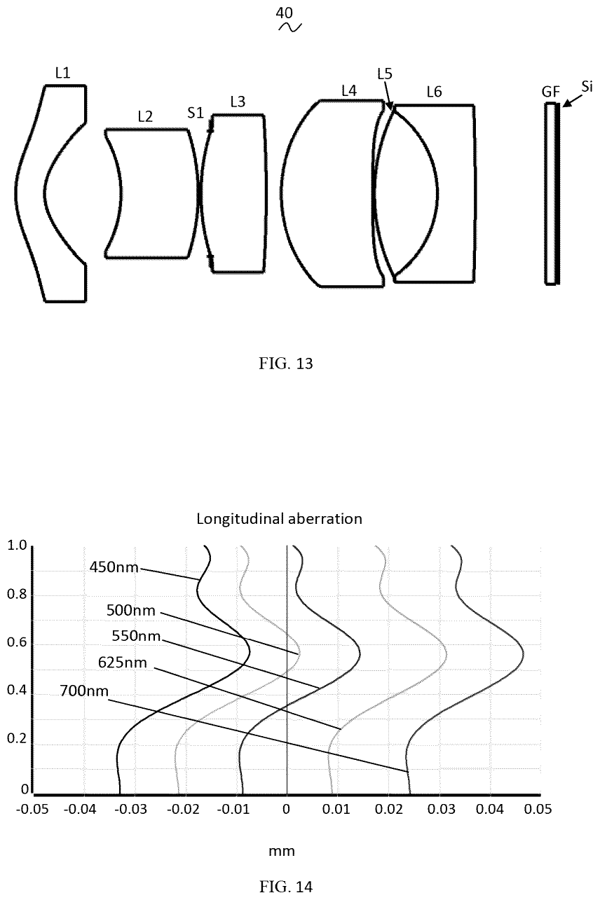

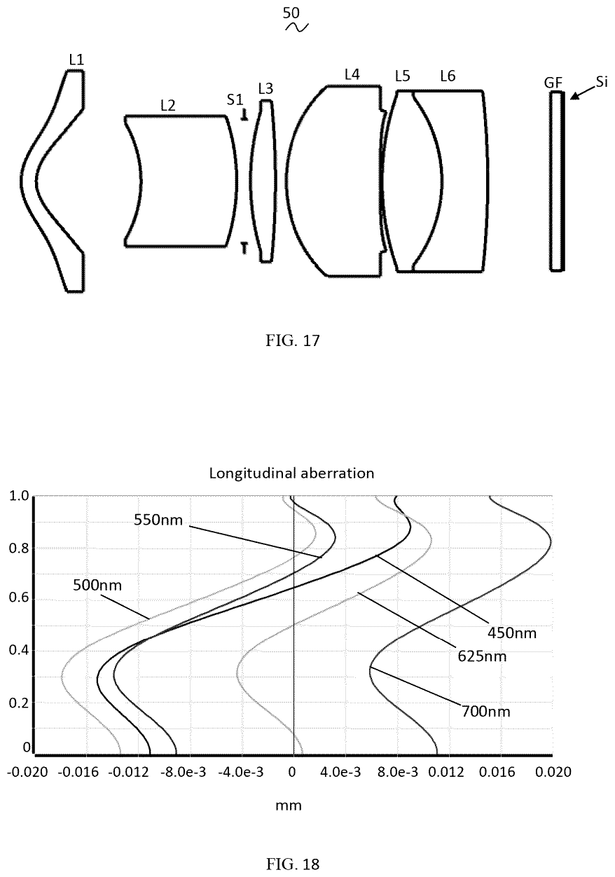

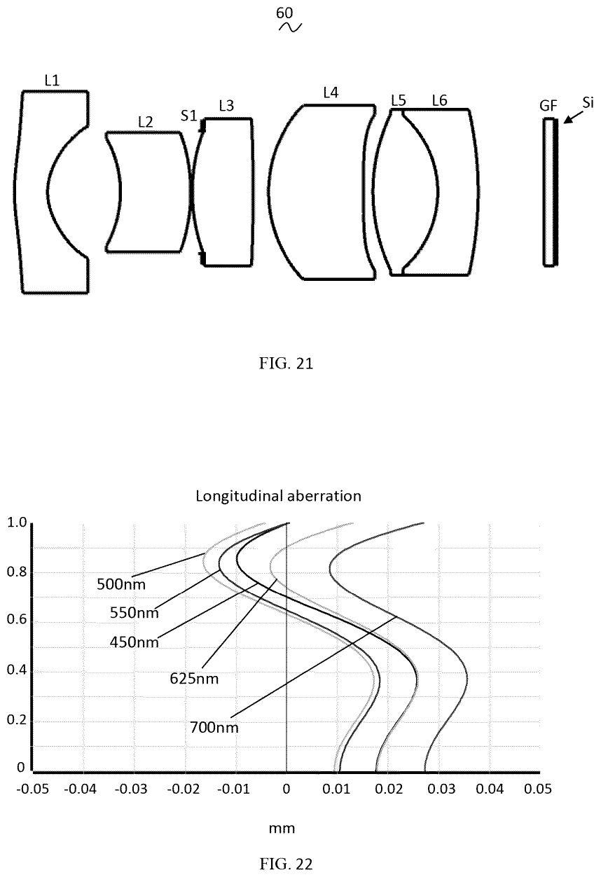

Referring to FIG. 1, FIG. 5, FIG. 9, FIG. 13, FIG. 17, and FIG. 21, the present disclosure provides a camera optical lens 10, 20, 30, 40, 50, and 60. FIG. 1, FIG. 5, FIG. 9, FIG. 13, FIG. 17, and FIG. 21 respectively shows the camera optical lens 10, the camera optical lens 20, the camera optical lens 30, the camera optical lens 40, the camera optical lens 50, and the camera optical lens 60. The camera optical lens includes six lenses in total. Specifically, from the object side to the image side, the camera optical lens includes in sequence: a first lens L1, a second lens L2, an aperture S1, a third lens L3, a fourth lens L4, a fifth lens L5, and a six lens L6. Optical elements like an optical filter GF may be arranged between the six lens L6 and the image surface Si.

The first lens L1 has a negative refractive power. The second lens L2 has a negative refractive power. The third lens L3 has a positive refractive power. The fourth lens L4 has a positive refractive power. The fifth lens L5 has a positive refractive power. The sixth lens L6 has a negative refractive power. In other optional embodiments, the respective lens of the camera optical lens may also have other refractive power.

The distance on axis between the image side surface of the first lens L1 and the object side surface of the second lens L2 is defined as d2. The total track length of the camera optical lens is defined as TTL. The following condition should be satisfied: 0.10≤d2/TTL≤0.20, which fixes the ratio between the distance between the first lens L1 and the second lens L2 and the total track length TTL. When the ratio is higher than the lower limit, light near the aperture can be smoothly translated and the lateral color can be corrected to ensure the imaging quality, and the total optical length TTL of the system can be effectively controlled, so that the amount of the field curvature offset of the center field of view is less than 0.01 mm. When the ratio is lower than the upper limit, it is beneficial to control the total track length of the camera optical lens.

The focal length of the third lens L3 is defined as f3, and the focal length of the fourth lens L4 is defined as f4. The following condition should be satisfied: 0.60≤f3/f4≤1.40, which fixes the ratio between the focal length f3 of the third lens L3 to the focal length f4 of the fourth lens L4. When the condition is satisfied, the focal length f3 of the third lens L3 is close to the focal length f4 of the fourth lens L4, which is beneficial for the light transition smoothly and the image quality can be improved.

The central curvature radius of the object side surface of the fourth lens L4 is defined as R7, and the central curvature radius of the image side surface of the fourth lens L4 is defined as R8. The following condition should be satisfied: 0.01≤R7/R8<0.30, which fixes the shape of the fourth lens L4. When the condition is satisfied, the degree of deflection of light passing through the fourth lens L4 can be eased, so that the camera optical lens can have better imaging quality and lower sensitivity.

In the case of satisfying the above conditions, the camera optical lens 10, 20, 30, 40, 50 and 60 has good optical performance and can meet the design requirements of a large aperture and wide angle. Based on the characteristics of the camera optical lens 10, 20, 30, 40, 50 and 60, the camera optical lens 10, 20, 30, 40, 50 and 60 is particularly suitable for in-vehicle lenses and WEB camera lenses, which includes camera elements such as CCD and CMOS for high pixel.

Based on the above conditions and the functions that can be achieved, the characteristics of each lens are further refined as follows.

The first lens L1 is made of glass material. The second lens L2 is made of glass material. The third lens L3 is made of glass material. The fourth lens L4 is made of glass material. The fifth lens L5 is made of glass material. The sixth lens L6 is made of glass material. The optical performance of camera optical lenses can be improved by appropriate selection of glass material. In other optional embodiments, the respective lens of the camera optical lens may also be made of other materials.

The first lens L1 is an aspherical lens, the second lens L2 is a spherical lens, the third lens L3 is a spherical lens, the fourth lens L4 is an aspherical lens, the fifth lens L5 is a spherical lens, and the sixth lens L6 is a spherical lens.

The central curvature radius of the object side surface of the first lens L1 is defined as R1, and the central curvature radius of the image side surface of the first lens L1 is defined as R2. The following condition should be satisfied: 1.80≤(R1+R2)/(R1−R2)≤6.30, by which, the shape of the first lens L1 is fixed. When the condition is satisfied, the degree of deflection of the light passing through the lens can be reduced and the chromatic aberration can be effectively corrected, so that the image quality can be improved.

The fifth lens L5 and the sixth lens L6 are glued together. The fifth lens L5 is provided glued to the sixth lens L6. The overall volume of the camera optical lens can be reduced by gluing setting. In addition, the fifth lens L5 and the sixth lens L6 are formed to be an overall structure by gluing setting, and the installation of the fifth lens L5 and the sixth lens L6 can be completed by a single placement when assembling the optical module.

The abbe number of the fifth lens L5 is defined as v5. The abbe number of the sixth lens L6 is defined as v6. The following condition should be satisfied: v5−v6≥35.00, which fixed the difference between the abbe number v5 of the fifth lens 5 and the able number v6 of the sixth lens L6 that are glued together. When the condition is satisfied, material properties can be effectively assigned, the lateral color can be effectively corrected, and the imaging quality of the camera optical lens 10 can be improved, so that the lateral color is less than or equal to 8 μm.

The total track length of the camera optical lens 10 is defined as TTL. The following condition should be satisfied: 5.00≤TTL/f≤7.00, which fixes the telescope ratio. By setting the telescope ratio smaller than the upper limit value of the condition, the total track length can be controlled to be shorter, and miniaturization can be realized easily. On the other hand, by setting the telescope ratio larger than the lower limit value of the condition, the distortion and the aberration on-axis are easily to be corrected, and good optical performance can be maintained.

The object side surface of the first lens L1 is convex in a paraxial region, and the image side surface of the first lens L1 is concave in the paraxial region. The object side surface and the image side surface of the first lens L1 may also be provided with other concave and convex distributions.

The focal length of the first lens L1 is defined as f1. The following condition should be satisfied: −6.21≤f1/f≤−0.97, which fixes the ration between the focal length f1 of the first lens L1 and the focal length f of the camera optical lens, and it is beneficial for achieving ultra-wide angel. Preferably, the following condition shall be satisfied, −3.88≤f1/f≤−1.22.

The thickness on-axis of the first lens L1 is defined as d1. The following condition should be satisfied: 0.01≤d1/TTL≤0.10, which is beneficial for the realization of miniaturization. Preferably, the following condition shall be satisfied, 0.02≤d1/TTL≤0.08.

The object side surface of the second lens L2 is concave in the paraxial region, and the image side surface of the second lens L2 is convex in the paraxial region. The object side surface of the second lens L2 may also be provided with other concave and convex distributions.

The focal length of the camera optical lens is defined as f, and the focal length of the second lens L2 is defined as f2. The camera optical lens 10 satisfies the following condition: −21.11≤f2/f≤−3.75, which fixes the ratio between the focal length f2 of the second lens L2 and the total focal length f of the camera optical lens. When the condition is satisfied, the amount of the field curvature of the camera optical lens can be effectively balanced. Preferably, the following condition shall be satisfied, −13.19≤f2/f≤−4.69.

The central curvature radius of the object side surface of the second lens L2 is defined as R3, and the central curvature radius of the image side surface of the second lens L2 is defined as R4. The following condition should be satisfied: −9.81≤(R3+R4)/(R3−R4)≤−2.45, which fixes the shape of the second lens L2. When the condition is satisfied, it is beneficial for correcting the aberration of the axis with the development of the lens to ultra-thin and wide-angle. Preferably, the following condition shall be satisfied, −6.13≤(R3+R4)/(R3−R4)≤−3.06 is satisfied.

The thickness on-axis of the second lens L2 is defined as d3. The following condition should be satisfied: 0.06≤d3/TTL≤0.26, by which, it is beneficial for the realization of miniaturization. Preferably, the following condition shall be satisfied, 0.10≤d3/TTL≤0.21.

The object side surface of the third lens L3 is convex in the paraxial region, and the image side surface of the third lens L3 is convex in the paraxial region. The object side surface and the image side surface of the third lens L3 may also be provided with other concave and convex distributions.

The focal length of the third lens L3 is defined as f3. The following condition: 1.18≤f3/f≤5.80 should be satisfied, which fixes the ration between the focal length f3 of the third lens L3 and the focal length f of the camera optical lens. When f3/f satisfies the above condition, by controlling the focal length of the third lens L3 and allocating the focal length reasonably, it is beneficial to control the temperature drift and achieve better temperature performance. Preferably, the following condition shall be satisfied, 1.89≤f3/f≤4.64.

The central curvature radius of the object side surface of the third lens L3 is defined as R5, and the central curvature radius of the image side surface of the third lens L3 is defined as R6. The following condition should be satisfied: −1.96≤(R5+R6)/(R5−R6)≤−0.31, by which, the shape of the third lens L3 is fixed. When the condition is satisfied, the degree of deflection of the light passing through the lens can be reduced and the lateral color can be effectively corrected. Preferably, the following condition shall be satisfied, −1.22≤(R5+R6)/(R5−R6)≤−0.38.

The thickness on-axis of the third lens L3 is defined as d5. The following condition should be satisfied: 0.02≤d5/TTL≤0.26, by which, it is beneficial for the realization of miniaturization. Preferably, the following condition shall be satisfied, 0.04≤d5/TTL≤0.20.

The object side surface of the fourth lens L4 is convex in the paraxial region, and the image side surface of the fourth lens L4 is concave in the paraxial region. The image side surface of the fourth lens L4 may also be provided with other concave and convex distributions.

The focal length of the fourth lens L4 is defined as f4. The following condition: 1.29≤f4/f≤5.84 should be satisfied. By distributing the focal power of the fourth lens L4 appropriately, the camera optical lens can have better imaging quality and lower sensitivity. Preferably, the following condition shall be satisfied, 2.06≤f4/f≤4.67.

The central curvature radius of the object side surface of the fourth lens L4 is defined as R7, and the central curvature radius of the image side surface of the fourth lens L4 is defined as R8. The following condition should be satisfied: −3.71≤(R7+R8)/(R7−R8)≤−0.68, which fixes the shape of the fourth lens L4. When the condition is satisfied, it is beneficial for correcting the aberration of the image of the off axis drawing angle, among other things, as the camera optical lens 10 with the development of long coking. Preferably, the following condition shall be satisfied, −2.32≤(R7+R8)/(R7−R8)≤−0.85.

The thickness on-axis of the fourth lens L4 is defined as d7. The following condition should be satisfied: 0.07≤d7/TTL≤0.26, by which, it is beneficial for the realization of miniaturization. Preferably, the following condition shall be satisfied, 0.11≤d7/TTL≤0.21.

The object side surface of the fifth lens L5 is convex in the paraxial region, and the image side surface of the fifth lens L5 is convex in the paraxial region. The object side surface and the image side surface of the fifth lens L5 may also be provided with other concave and convex distributions.

The focal length of the fifth lens L5 is defined as f5. The following condition should be satisfied: 0.56≤f5/f≤2.34. By distributing the focal power of the fifth lens L5 appropriately, the camera optical lens can have better imaging quality and lower sensitivity. Preferably, the following condition shall be satisfied, 0.89≤f5/f≤1.87.

The central curvature radius of the object side surface of the fifth lens L5 is defined as R9, and the central curvature radius of the image side surface of the fifth lens L5 is defined as R10. The following condition should be satisfied: 0.13≤(R9+R10)/(R9−R10)≤0.50, which fixes the shape of the fifth lens L5. When the condition is satisfied, it is beneficial for correcting the aberration of the image of the off axis drawing angle, among other things, with the development of wide angle. Preferably, the following condition shall be satisfied, 0.21≤(R9+R10)/(R9-R10)≤0.40.

The thickness on-axis of the fifth lens L5 is defined as d9. The following condition should be satisfied: 0.05≤d9/TTL≤0.18, by which, it is beneficial for the realization of miniaturization. Preferably, the following condition shall be satisfied, 0.08≤d9/TTL≤0.14.

The object side surface of the sixth lens L6 is concave in the paraxial region, and the image side surface of the sixth lens L6 is convex in the paraxial region. The object side surface and the image side surface of the sixth lens L6 may also be provided with other concave and convex distributions.

The focal length of the sixth lens L6 is defined as f6. The following condition should be satisfied: −4.36≤f6/f≤≤−0.83, which specifies that the last lens, the sixth lens L6, has a short focal length. When the condition is satisfied, it is beneficial for the light receiving and ensuring the light throughput. Preferably, the following condition shall be satisfied, −2.73≤f6/f≤−1.03.

The central curvature radius of the object side surface of the sixth lens L6 is defined as R11, and the central curvature radius of the image side surface of the sixth lens L6 is defined as R12. The following condition should be satisfied: −3.71≤(R11+R12)/(R11−R12)≤−0.72, which fixes the shape of the sixth lens L6 that contributes to a smooth transition of the light and improves the imaging quality. Preferably, the following condition shall be satisfied, −2.32≤(R11+R12)/(R11−R12)≤−0.90.

The thickness on-axis of the sixth lens L6 is defined as d11. The following condition: 0.03≤d11/TTL≤0.13 should be satisfied. When the condition is satisfied, it is beneficial for realization of miniaturization. Preferably, the following condition shall be satisfied, 0.06≤d11/TTL≤0.11.

The camera optical lens of the present disclosure will be described below by way of examples. The various symbols recorded in each example are shown below. The focal length, distance on-axis, center curvature radius, and thickness on-axis are all in units of mm.

TTL: Total track length (the distance from the object-side surface of the first lens L1 to the image surface Si of the camera optical lens along the optical axis), and the unit of TTL is mm.

Aperture value FNO: a ratio of the effective focal length of the camera optical lens to the entrance pupil diameter of the camera optical lens.

The technical scheme of the present disclosure is specifically described in six embodiments, and at the same time, a contrast embodiment is provided as a reference, and the technical effect of the present disclosure cannot be realized beyond the scope of the above conditions.

### First Embodiment

Table 1 shows the design data of the camera optical lens 10 in the first embodiment of the present disclosure. FIG. 1 shows a schematic diagram of a structure of a camera optical lens 10 in the first embodiment of the present disclosure.

TABLE 1

| | R | d | | nd | | νd | |
|---|---|---|---|---|---|---|---|
| S1 | ∞ | d0= | −8.693 | | | | |
| R1 | 4.743 | d1= | 1.420 | nd1 | 1.7433 | ν1 | 49.34 |
| R2 | 2.428 | d2= | 3.503 | | | | |
| R3 | −5.140 | d3= | 3.661 | nd2 | 1.7015 | ν2 | 41.14 |
| R4 | −8.729 | d4= | 0.100 | | | | |
| R5 | 11.190 | d5= | 3.676 | nd3 | 1.5891 | ν3 | 61.25 |
| R6 | −30.110 | d6= | 1.289 | | | | |
| R7 | 6.348 | d7= | 4.500 | nd4 | 1.4970 | ν4 | 81.61 |
| R8 | 143.483 | d8= | 0.100 | | | | |
| R9 | 10.881 | d9= | 3.257 | nd5 | 1.5891 | ν5 | 61.25 |
| R10 | −6.203 | d10= | 0.000 | | | | |
| R11 | −6.203 | d11= | 2.355 | nd6 | 1.9460 | ν6 | 17.94 |
| R12 | −23.729 | d12= | 3.289 | | | | |
| R13 | ∞ | d13= | 0.500 | ndg | 1.5168 | νg | 64.17 |
| R14 | ∞ | d14= | 0.150 | | | | |

In which, the meaning of the various symbols is as follows.
S1: Aperture;
R: The curvature radius at the center of the optical surfac;
R1: The central curvature radius of the object side surface of the first lens L1;
R2: The central curvature radius of the image side surface of the first lens L1;
R3: The central curvature radius of the object side surface of the second lens L2;
R4: The central curvature radius of the image side surface of the second lens L2;
R5: The central curvature radius of the object side surface of the third lens L3;
R6: The central curvature radius of the image side surface of the third lens L3;
R7: The central curvature radius of the object side surface of the fourth lens L4;
R8: The central curvature radius of the image side surface of the fourth lens L4;
R9: The central curvature radius of the object side surface of the fifth lens L5;
R10: The central curvature radius of the image side surface of the fifth lens L5;
R11: The central curvature radius of the object side surface of the sixth lens L6;
R12: The central curvature radius of the image side surface of the sixth lens L6;
R13: The central curvature radius of the object side surface of the optical filter GF;
R14: The center curvature radius of the image side surface of the optical filter GF;
d: The thickness on-axis of the lens, and the distance on-axis between the lenses;
d0: The distance on-axis from the aperture S1 to the object side surface of the first lens L1;
d1: The thickness on-axis of the first lens L1;
d2: The distance on-axis from the image side surface of the first lens L1 to the object side surface of the second lens L2;
d3: The thickness on-axis of the second lens L2;
d4: The distance on-axis from the image side surface of the second lens L2 and the object side surface of the third lens L3;
d5: The thickness on-axis of the third lens L3;
d6: The distance on-axis from the image side surface of the third lens L3 to the object side surface of the fourth lens L4;
d7: The thickness on-axis of f the fourth lens L4;
d8: The distance on-axis from the image side surface of the fourth lens L4 to the object side surface of the fifth lens L5;
d9: The thickness on-axis of the fifth lens L5;
d10: The distance on-axis from the image side surface of the fifth lens L5 to the object side surface of the sixth lens L6;
d11: The thickness on-axis of the sixth lens L6;
d12: The distance on-axis from the image side surface of the sixth lens L6 and the object side surface of the optical filter GF;
d13: The thickness on-axis of the optical filter GF;
d14: The distance on-axis from the image side surface of the optical filter GF to the image surface Si;
nd: The refractive power of d line (d line is green light with a wavelength of 550 nm);
nd1: The refractive power of the d line of the first lens L1;
nd2: The refractive power of the d line of the second lens L2;
nd3: The refractive power of the d line of the third lens L3;
nd4: The refractive power of the d line of the fourth lens LA;
nd5: The refractive power of the d line of the fifth lens L5;
nd6: The refractive power of the d line of the sixth lens L6;
ndg: The refractive power of d line of the optical filter GF;
vd: The abbe number;
v1: The abbe number of the first lens L1;
v2: The abbe number of the second lens L2;
v3: The abbe number of the third lens L3;
v4: The abbe number of the fourth lens L4;
v5: The abbe number of the fifth lens L5;
v6: The abbe number of the sixth lens L6;
vg: The abbe number of the optical filter GF.

Table 2 shows aspherical surface data of the camera optical lens 10 in in the first embodiment of the present disclosure.

Table 2 shows aspherical surface data of the first lens L1 and the fourth lens L4 of the camera optical lens 10 in in the first embodiment of the present disclosure.

TABLE 2

| | Conic coefficients | Aspheric surface coefficients | | | | |
|---|---|---|---|---|---|---|
| | k | A4 | A6 | A8 | A10 | A12 |
| R1 | −1.38143E+00 | −3.38990E−03 | −2.07650E−04 | 3.37470E−05 | −1.95530E−06 | 6.19130E−08 |
| R2 | −1.06953E+00 | −4.89750E−03 | −4.79190E−04 | 1.12290E−04 | −5.55380E−06 | −3.81210E−07 |
| R7 | −2.14616E+00 | 1.02030E−03 | 4.98890E−06 | 7.15940E−07 | −6.42520E−08 | 4.95860E−09 |
| R8 | −6.30178E+01 | 1.12110E−03 | 2.19770E−05 | 5.22960E−06 | −1.13100E−06 | 1.33850E−07 |

| | |
|---|---|
| Conic coefficients | Aspheric surface coefficients |

| | k | A14 | A16 |
|---|---|---|---|
| R1 | −1.38143E+00 | −1.04910E−09 | 7.38580E−12 |
| R2 | −1.06953E+00 | 5.76070E−08 | −1.86430E−09 |
| R7 | −2.14616E+00 | −1.86120E−10 | 3.25230E−12 |
| R8 | −6.30178E+01 | −7.41950E−09 | 1.68760E−10 |

For convenience, the aspheric of each lens is used the aspherical surfaces shown in formula (1) below. However, the present disclosure is not limited to the aspheric polynomial form represented by the formula (1).

$$z = ( {cr}^{2} ) / \{ 1 + [ 1 − {( k + 1 ) ( {c}^{2} {r}^{2} ) ]}^{1 / 2} \} + A 4 {r}^{4} + A 6 {r}^{6} + A 8 {r}^{8} + A 10 {r}^{10} + A 12 {r}^{12} + A 14 {r}^{14} + A 16 {r}^{16} \qquad ( 1 )$$

here k is the cone coefficient, A4, A6, A8, A10, A12, A14, and A16 are aspheric coefficients, c is the curvature at the center of the optical surface, r is the vertical distance between the point on the aspheric curve and the optical axis, and z is the aspherical depth (i.e., the vertical distance between a point on the aspherical surface r from the optical axis and a section tangent to the vertex on the aspherical optical axis).

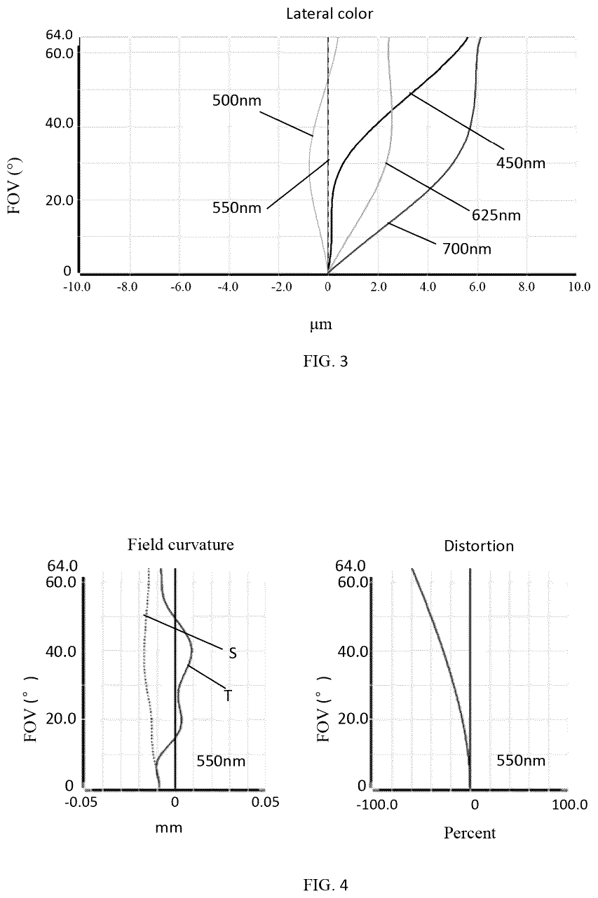

FIG. 2 and FIG. 3 respectively show the longitudinal aberration and lateral color schematic diagrams after light with wavelengths of 700 nm, 625 nm, 550 nm, 500 nm, and 450 nm passes through the camera optical lens 10 in the first embodiment. FIG. 4 shows the schematic diagrams of the field curvature and distortion after light with a wavelength of 550 nm passes through the camera optical lens 10 in the first embodiment. The field curvature S in FIG. 4 is a field curvature in the sagittal direction, and T is the field curvature in the meridian direction.

Table 15, which appears later, shows the values corresponding to the various numerical values in each embodiment and the parameters already specified in the conditions.

As shown in Table 15, the first embodiment satisfies each condition.

In this embodiment, the pupil entering diameter (ENPD) of the camera optical lens 10 is 3.036 mm, the image height (IH) of 1.0 H is 4.032 mm, and the field of view (FOV) in the diagonal direction is 128.00°. The camera optical lens 10 has good optical performance, and chromatic aberrations on-axis and chromatic aberrations off-axis are adequately corrected. And the camera optical lens 10 has excellent optical characteristics.

### Second Embodiment

The meaning of symbols in the second embodiment is basically the same as that in the first embodiment. Only the differences are listed below.

FIG. 5 shows a schematic diagram of a structure of a camera optical lens 20 in the second embodiment of the present disclosure.

Table 3 shows design data of the camera optical lens 20 in the second embodiment of the present disclosure.

TABLE 3

| | R | d | | nd | | νd | |
|---|---|---|---|---|---|---|---|
| S1 | ∞ | d0= | −10.054 | | | | |
| R1 | 6.666 | d1= | 2.001 | nd1 | 1.7433 | ν1 | 49.34 |
| R2 | 2.619 | d2= | 2.980 | | | | |
| R3 | −5.535 | d3= | 3.945 | nd2 | 1.7015 | ν2 | 41.14 |
| R4 | −9.044 | d4= | 0.712 | | | | |
| R5 | 9.933 | d5= | 5.001 | nd3 | 1.5891 | ν3 | 61.25 |
| R6 | −886.578 | d6= | 0.493 | | | | |
| R7 | 5.905 | d7= | 4.467 | nd4 | 1.4970 | ν4 | 81.61 |
| R8 | 576.149 | d8= | 0.290 | | | | |
| R9 | 9.876 | d9= | 3.528 | nd5 | 1.5891 | ν5 | 61.25 |
| R10 | −5.740 | d10= | 0.000 | | | | |
| R11 | −5.740 | d11= | 2.162 | nd6 | 1.9460 | ν6 | 17.94 |
| R12 | −19.160 | d12= | 3.233 | | | | |
| R13 | ∞ | d13= | 0.500 | ndg | 1.5168 | νg | 64.17 |
| R14 | ∞ | d14= | 0.105 | | | | |

Table 4 shows aspherical surface data of the first lens L1 and the fourth lens L4 of the camera optical lens 20 in the second embodiment of the present disclosure.

TABLE 4

| | Conic coefficients | Aspheric surface coefficients | | | | |
|---|---|---|---|---|---|---|
| | k | A4 | A6 | A8 | A10 | A12 |
| R1 | −9.82104E−01 | −2.65940E−03 | −2.12860E−05 | 7.36670E−06 | −3.68220E−07 | 9.60780E−09 |
| R2 | −9.07890E−01 | −5.27420E−03 | 6.69430E−04 | −2.23720E−04 | 5.14880E−05 | −6.27010E−06 |
| R7 | −1.89289E+00 | 1.00400E−03 | 4.85200E−05 | −4.36370E−06 | 6.62840E−08 | 3.54850E−08 |
| R8 | 2.53660E+04 | 1.73960E−03 | −8.76430E−05 | 3.82550E−05 | −6.55350E−06 | 6.69270E−07 |

| | |
|---|---|
| Conic coefficients | Aspheric surface coefficients |

| | k | A14 | A16 |
|---|---|---|---|
| R1 | −9.82104E−01 | −1.35370E−10 | 8.16250E−13 |
| R2 | −9.07890E−01 | 3.96980E−07 | −9.90960E−09 |
| R7 | −1.89289E+00 | −2.95860E−09 | 7.39100E−11 |
| R8 | 2.53660E+04 | −3.56540E−08 | 7.90250E−10 |

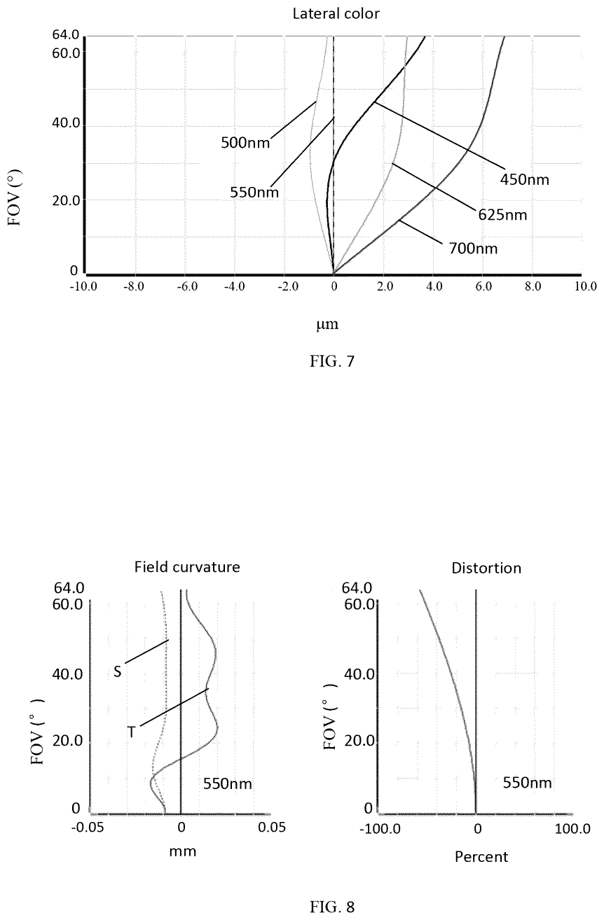

FIG. 6 and FIG. 7 respectively show the longitudinal aberration and lateral color schematic diagrams after light with wavelengths of 700 nm, 625 nm, 550 nm, 500 nm, and 450 nm passes through the camera optical lens 20 in the second embodiment. FIG. 8 shows the schematic diagrams of the field curvature and distortion after light with a wavelength of 550 nm passes through the camera optical lens 20 in the second implementation. The field curvature S in FIG. 8 is a field curvature in the sagittal direction, and T is the field curvature in the meridian direction.

As shown in Table 15, the second embodiment satisfies each condition.

In this embodiment, the pupil entering diameter (ENPD) of the camera optical lens 20 is 2.693 mm, the image height (IH) of 1.0 H is 3.768 mm, and the field of view (FOV) in the diagonal direction is 128.0°. The camera optical lens 20 has good optical performance, and chromatic aberrations on-axis and chromatic aberrations off-axis are adequately corrected. And the camera optical lens 20 has excellent optical characteristics.

### Third Embodiment

The meaning of symbols in the third embodiment is basically the same as that in the first embodiment. Only the differences are listed below.

FIG. 9 shows the camera optical lens 30 in the third embodiment of the present disclosure.

Table 5 shows the design data of the camera optical lens 30 in the third embodiment of the present disclosure.

TABLE 5

| | R | d | | nd | | νd | |
|---|---|---|---|---|---|---|---|
| S1 | ∞ | d0= | −11.860 | | | | |
| R1 | 3.541 | d1= | 1.614 | nd1 | 1.7433 | ν1 | 49.34 |
| R2 | 2.129 | d2= | 5.090 | | | | |
| R3 | −5.332 | d3= | 3.864 | nd2 | 1.7015 | ν2 | 41.14 |
| R4 | −8.064 | d4= | 0.799 | | | | |
| R5 | 7.362 | d5= | 1.495 | nd3 | 1.5891 | ν3 | 61.25 |
| R6 | −204.866 | d6= | 0.500 | | | | |
| R7 | 7.387 | d7= | 3.494 | nd4 | 1.4970 | ν4 | 81.61 |
| R8 | 24.641 | d8= | 0.080 | | | | |
| R9 | 10.722 | d9= | 2.655 | nd5 | 1.5891 | ν5 | 61.25 |
| R10 | −5.330 | d10= | 0.000 | | | | |
| R11 | −5.330 | d11= | 2.274 | nd6 | 1.9460 | ν6 | 17.94 |
| R12 | −18.281 | d12= | 3.034 | | | | |
| R13 | ∞ | d13= | 0.500 | ndg | 1.5168 | νg | 64.17 |
| R14 | ∞ | d14= | 0.080 | | | | |

Table 6 shows the aspheric data of the first lens L1 and the fourth lens L4 of the camera optical lens 30 in the third embodiment of the present disclosure.

TABLE 6

| | conic coefficients | Aspheric surface coefficients | | | | |
|---|---|---|---|---|---|---|
| | k | A4 | A6 | A8 | A10 | A12 |
| R1 | −1.22895E+00 | 4.77630E−05 | −1.67040E−04 | −4.28840E−06 | 9.41850E−07 | −4.07960E−08 |
| R2 | −1.02531E+00 | 1.22580E−03 | −1.26100E−03 | 1.86180E−04 | −2.22380E−05 | 1.91960E−06 |
| R7 | −2.15817E+00 | 6.41790E−04 | 1.38210E−04 | −5.47410E−05 | 1.22770E−05 | −1.48220E−06 |
| R8 | 5.33875E+01 | 3.37920E−04 | 6.94570E−04 | −2.43280E−04 | 4.64070E−05 | −4.69510E−06 |

| | |
|---|---|
| conic coefficients | Aspheric surface coefficients |

| | k | A14 | A16 |
|---|---|---|---|
| R1 | −1.22895E+00 | 7.76620E−10 | −5.71640E−12 |
| R2 | −1.02531E+00 | −9.15020E−08 | 1.80920E−09 |
| R7 | −2.15817E+00 | 8.92370E−08 | −2.03980E−09 |
| R8 | 5.33875E+01 | 2.32680E−07 | −4.40730E−09 |

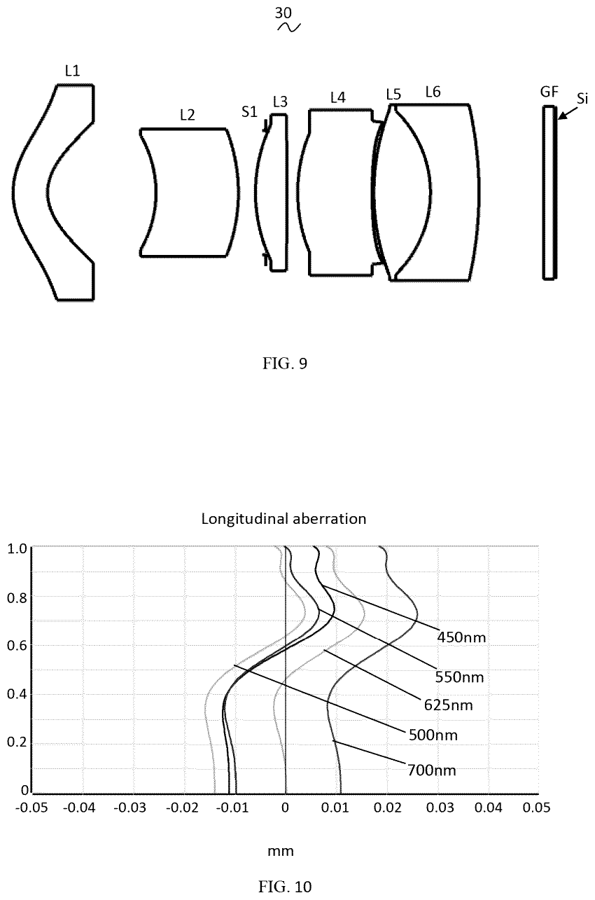

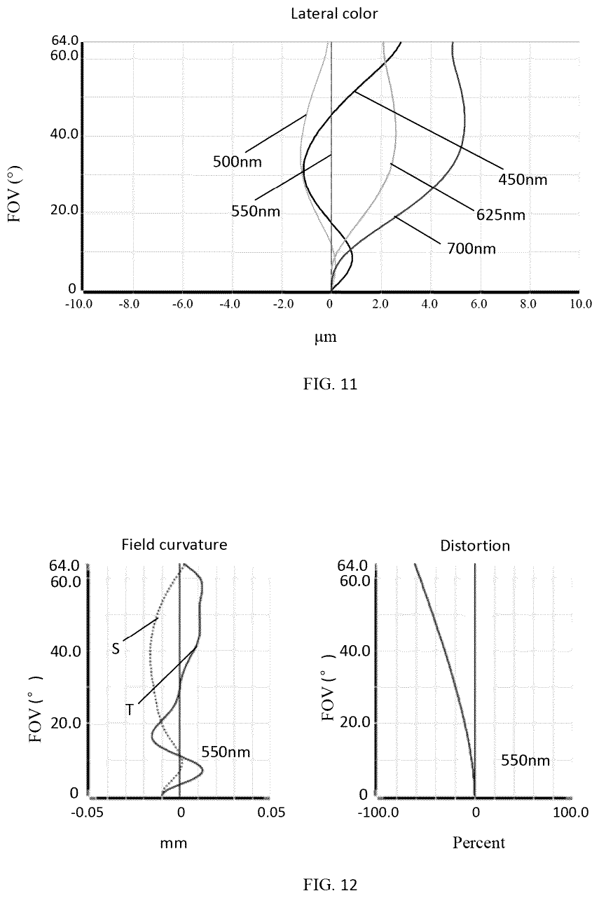

FIG. 10 and FIG. 11 respectively show the longitudinal aberration and lateral color schematic diagrams after light with wavelengths of 700 nm, 625 nm, 550 nm, 500 nm, and 450 nm passes through the camera optical lens 30 in the third embodiment. FIG. 12 shows the schematic diagrams of the field curvature and distortion after light with a wavelength of 550 nm passes through the camera optical lens 30 in the third embodiment. The field curvature S in FIG. 12 is a field curvature in the sagittal direction, and T is the field curvature in the meridian direction.

The Table 15 shows later lists the values of the corresponding conditions in this embodiment according to the above conditions. Obviously, the camera optical lens 30 of the embodiment satisfies the above conditions.

In this embodiment, the pupil entering diameter (ENPD) of the camera optical lens 30 is 3.183 mm, the image height (IH) of 1.0 H is 4.026 mm, and the field of view (FOV) in the diagonal direction is 128.00°. The camera optical lens 30 has good optical performance, and chromatic aberrations on-axis and chromatic aberrations off-axis are adequately corrected. And the camera optical lens 30 has excellent optical characteristics.

### Fourth Embodiment

The meaning of symbols in the fourth embodiment is basically the same as that in the first embodiment. Only the differences are listed below.

FIG. 13 shows the camera optical lens 40 in the fourth embodiment of the present disclosure.

Table 7 and table 8 show the design data of the camera optical lens 40 in the fourth embodiment of the present disclosure.

TABLE 7

| | R | d | | nd | | νd | |
|---|---|---|---|---|---|---|---|
| S1 | ∞ | d0= | −9.068 | | | | |
| R1 | 4.060 | d1= | 1.347 | nd1 | 1.7433 | ν1 | 49.34 |
| R2 | 2.294 | d2= | 3.561 | | | | |
| R3 | −5.350 | d3= | 3.599 | nd2 | 1.7015 | ν2 | 41.14 |
| R4 | −9.337 | d4= | 0.129 | | | | |
| R5 | 9.625 | d5= | 3.038 | nd3 | 1.5891 | ν3 | 61.25 |
| R6 | −56.673 | d6= | 0.699 | | | | |
| R7 | 6.337 | d7= | 4.278 | nd4 | 1.4970 | ν4 | 81.61 |
| R8 | 263.340 | d8= | 0.080 | | | | |
| R9 | 8.662 | d9= | 2.934 | nd5 | 1.5891 | ν5 | 61.25 |
| R10 | −4.673 | d10= | 0.000 | | | | |
| R11 | −4.673 | d11= | 1.764 | nd6 | 1.7847 | ν6 | 25.72 |
| R12 | −113.386 | d12= | 3.270 | | | | |
| R13 | ∞ | d13= | 0.500 | ndg | 1.5168 | νg | 64.17 |
| R14 | ∞ | d14= | 0.115 | | | | |

Table 8 shows aspherical surface data of the first lens L1 and the fourth lens L4 of the camera optical lens 40 in the fourth embodiment of the present disclosure.

TABLE 8

| | conic coefficients | Aspheric surface coefficients | | | | |
|---|---|---|---|---|---|---|
| | k | A4 | A6 | A8 | A10 | A12 |
| R1 | −1.34530E+00 | −2.76700E−03 | −1.30970E−04 | 7.36740E−06 | 5.91520E−07 | −6.05780E−08 |
| R2 | −1.04823E+00 | −5.21300E−03 | 2.95900E−04 | −1.56680E−04 | 3.76320E−05 | −4.15840E−06 |
| R7 | −2.04240E+00 | 1.22560E−03 | −1.45950E−04 | 5.35770E−05 | −9.27180E−06 | 8.59480E−07 |
| R8 | 3.69741E+03 | 1.79990E−03 | −1.71560E−04 | 4.50280E−05 | −6.40590E−06 | 6.01060E−07 |

| | |
|---|---|
| conic coefficients | Aspheric surface coefficients |

| | k | A14 | A16 |
|---|---|---|---|
| R1 | −1.34530E+00 | 1.98220E−09 | −2.34530E−11 |
| R2 | −1.04823E+00 | 2.29930E−07 | −4.87430E−09 |
| R7 | −2.04240E+00 | −4.02750E−08 | 7.44900E−10 |
| R8 | 3.69741E+03 | −3.29080E−08 | 7.81330E−10 |

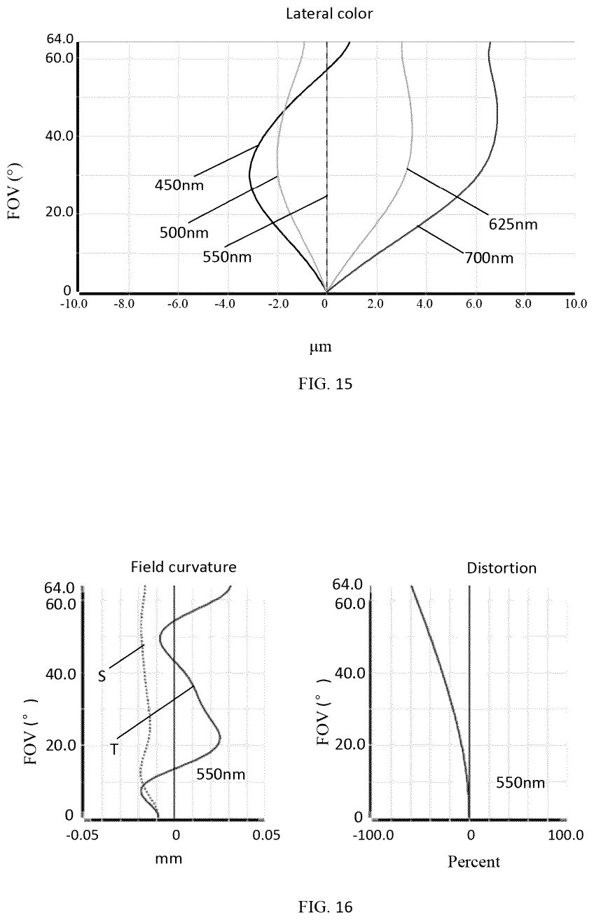

FIG. 14 and FIG. 15 respectively show the longitudinal aberration and lateral color schematic diagrams after light with wavelengths of 700 nm, 625 nm, 550 nm, 500 nm, and 450 nm passes through the camera optical lens 40 in the fourth embodiment. FIG. 16 shows the schematic diagrams of the field curvature and distortion after light with a wavelength of 550 nm passes through the camera optical lens 40 in the fourth embodiment. The field curvature S in FIG. 16 is a field curvature in the sagittal direction, and T is the field curvature in the meridian direction.

The Table 15 shows later lists the values of the corresponding conditions in this embodiment according to the above conditions. Obviously, the camera optical lens 40 of the embodiment satisfies the above conditions.

In this embodiment, the pupil entering diameter (ENPD) of the camera optical lens 40 is 3.150 mm, the image height (IH) of 1.0 H is 4.201 mm, and the field of view (FOV) in the diagonal direction is 128.00°. The camera optical lens 40 has good optical performance, and chromatic aberrations on-axis and chromatic aberrations off-axis are adequately corrected. And the camera optical lens 40 has excellent optical characteristics.

### Fifth Embodiment

The meaning of symbols in the fourth embodiment is basically the same as that in the first embodiment. Only the differences are listed below.

FIG. 17 shows the camera optical lens 40 in the fifth embodiment of the present disclosure.

Table 9 shows the design data of the camera optical lens 50 in the fifth embodiment of the present disclosure.

TABLE 9

| | R | d | | nd | | νd | |
|---|---|---|---|---|---|---|---|
| S1 | ∞ | d0= | −10.186 | | | | |
| R1 | 2.263 | d1= | 0.694 | nd1 | 1.7433 | ν1 | 49.34 |
| R2 | 1.642 | d2= | 4.776 | | | | |
| R3 | −5.276 | d3= | 4.365 | nd2 | 1.7015 | ν2 | 41.14 |
| R4 | −9.228 | d4= | 0.631 | | | | |
| R5 | 11.191 | d5= | 1.137 | nd3 | 1.5891 | ν3 | 61.25 |
| R6 | −37.139 | d6= | 0.500 | | | | |
| R7 | 6.290 | d7= | 4.299 | nd4 | 1.4970 | ν4 | 81.61 |
| R8 | 134.965 | d8= | 0.080 | | | | |
| R9 | 11.820 | d9= | 2.732 | nd5 | 1.5891 | ν5 | 61.25 |
| R10 | −6.289 | d10= | 0.000 | | | | |
| R11 | −6.289 | d11= | 2.088 | nd6 | 1.9460 | ν6 | 17.94 |
| R12 | −36.754 | d12= | 2.884 | | | | |
| R13 | ∞ | d13= | 0.500 | ndg | 1.5168 | νg | 64.17 |
| R14 | ∞ | d14= | 0.080 | | | | |

Table 10 shows aspherical surface data of the first lens Ll and the fourth lens L4 of the camera optical lens 50 in the fifth embodiment of the present disclosure.

TABLE 10

| | conic coefficients | Aspheric surface coefficients | | | | |
|---|---|---|---|---|---|---|
| | k | A4 | A6 | A8 | A10 | A12 |
| R1 | −1.46005E+00 | 3.62320E−03 | −2.34730E−03 | 2.71710E−04 | −1.64030E−05 | 5.74690E−07 |
| R2 | −1.15805E+00 | 3.72980E−03 | −4.99760E−03 | 9.60890E−04 | −1.05020E−04 | 7.18880E−06 |
| R7 | −1.82017E+00 | 1.17710E−03 | −5.47100E−05 | 2.17190E−05 | −3.62510E−06 | 3.55370E−07 |
| R8 | 1.74793E+03 | 1.34550E−03 | 4.22420E−05 | 2.77390E−05 | −9.04950E−06 | 1.35110E−06 |

| | |
|---|---|
| conic coefficients | Aspheric surface coefficients |

| | k | A14 | A16 |
|---|---|---|---|
| R1 | −1.46005E+00 | −1.10800E−08 | 9.12400E−11 |
| R2 | −1.15805E+00 | −2.81210E−07 | 4.76340E−09 |
| R7 | −1.82017E+00 | −1.81240E−08 | 3.61010E−10 |
| R8 | 1.74793E+03 | −9.34420E−08 | 2.43550E−09 |

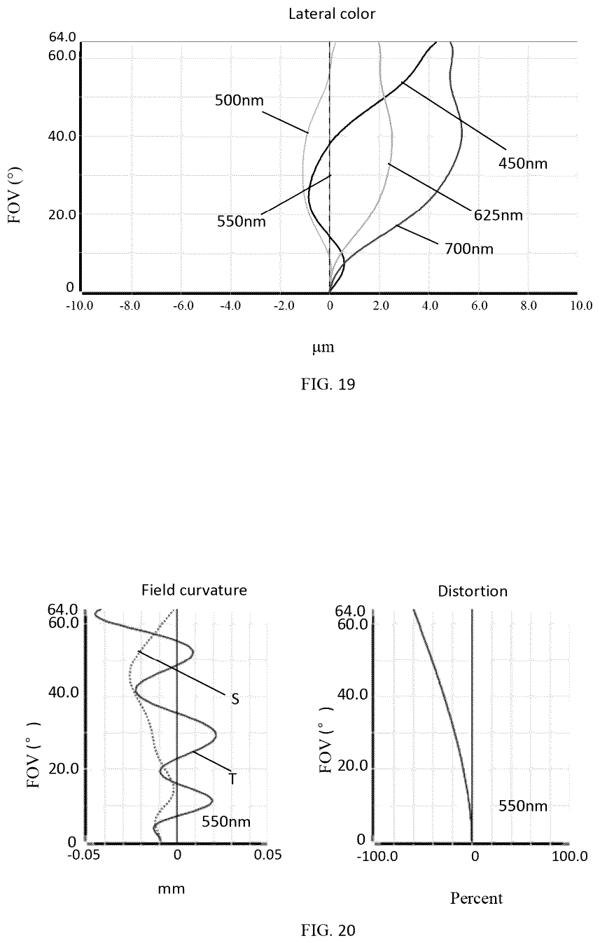

FIG. 18 and FIG. 19 respectively show the longitudinal aberration and lateral color schematic diagrams after light with wavelengths of 700 nm, 625 nm, 550 nm, 500 nm, and 450 nm passes through the camera optical lens 50 in the fifth embodiment. FIG. 20 shows the schematic diagrams of the field curvature and distortion after light with a wavelength of 550 nm passes through the camera optical lens 50 in the fifth embodiment. The field curvature S in FIG. 20 is a field curvature in the sagittal direction, and T is the field curvature in the meridian direction.

The Table 15 shows later lists the values of the corresponding conditions in this embodiment according to the above conditions. Obviously, the camera optical lens 50 of the embodiment satisfies the above conditions.

In this embodiment, the pupil entering diameter (ENPD) of the camera optical lens 50 is 3.093 mm, the image height (IH) of 1.0 H is 4.068 mm, and the field of view (FOV) in the diagonal direction is 128.00°. The camera optical lens 50 has good optical performance, and chromatic aberrations on-axis and chromatic aberrations off-axis are adequately corrected. And the camera optical lens 50 has excellent optical characteristics.

### Sixth Embodiment

The meaning of symbols in the fourth embodiment is basically the same as that in the first embodiment. Only the differences are listed below.

FIG. 21 shows the camera optical lens 60 in the sixth embodiment of the present disclosure.

Table 11 shows the design data of the camera optical lens 60 in the sixth embodiment of the present disclosure.

TABLE 11

| | R | d | | nd | | νd | |
|---|---|---|---|---|---|---|---|
| S1 | ∞ | d0= | −9.315 | | | | |
| R1 | 9.406 | d1= | 1.645 | nd1 | 1.7433 | ν1 | 49.34 |
| R2 | 2.717 | d2= | 3.618 | | | | |
| R3 | −5.512 | d3= | 3.493 | nd2 | 1.7015 | ν2 | 41.14 |
| R4 | −8.770 | d4= | 0.080 | | | | |
| R5 | 8.705 | d5= | 3.018 | nd3 | 1.5891 | ν3 | 61.25 |
| R6 | −85.033 | d6= | 0.770 | | | | |
| R7 | 6.291 | d7= | 4.728 | nd4 | 1.4970 | ν4 | 81.61 |
| R8 | 254.483 | d8= | 0.472 | | | | |
| R9 | 9.037 | d9= | 3.219 | nd5 | 1.5891 | ν5 | 61.25 |
| R10 | −5.102 | d10= | 0.000 | | | | |
| R11 | −5.102 | d11= | 2.008 | nd6 | 1.9460 | ν6 | 17.94 |
| R12 | −18.468 | d12= | 3.282 | | | | |
| R13 | ∞ | d13= | 0.500 | ndg | 1.5168 | νg | 64.17 |
| R14 | ∞ | d14= | 0.131 | | | | |

Table 12 shows aspherical surface data of the first lens L1 and the fourth lens L4 of the camera optical lens 60 in the sixth embodiment of the present disclosure.

TABLE 12

| | conic coefficients | Aspheric surface coefficients | | | | |
|---|---|---|---|---|---|---|
| | k | A4 | A6 | A8 | A10 | A12 |
| R1 | −4.99957E−01 | −4.11010E−03 | 2.01850E−04 | −6.34510E−06 | 1.33130E−07 | −2.08060E−09 |
| R2 | −8.05190E−01 | −9.05010E−03 | 2.81590E−03 | −9.11930E−04 | 1.89960E−04 | −2.22900E−05 |
| R7 | −2.24764E+00 | 1.02420E−03 | 7.71420E−06 | 2.24510E−06 | −6.54220E−07 | 6.86600E−08 |
| R8 | 3.87873E+03 | 2.06970E−03 | −1.13900E−04 | 3.13090E−05 | −4.42730E−06 | 4.04110E−07 |

| | |
|---|---|
| conic coefficients | Aspheric surface coefficients |

| | k | A14 | A16 |
|---|---|---|---|
| R1 | −4.99957E−01 | 2.60650E−11 | −1.81520E−13 |
| R2 | −8.05190E−01 | 1.37590E−06 | −3.43920E−08 |
| R7 | −2.24764E+00 | −3.46540E−09 | 7.22970E−11 |
| R8 | 3.87873E+03 | −2.04290E−08 | 4.26480E−10 |

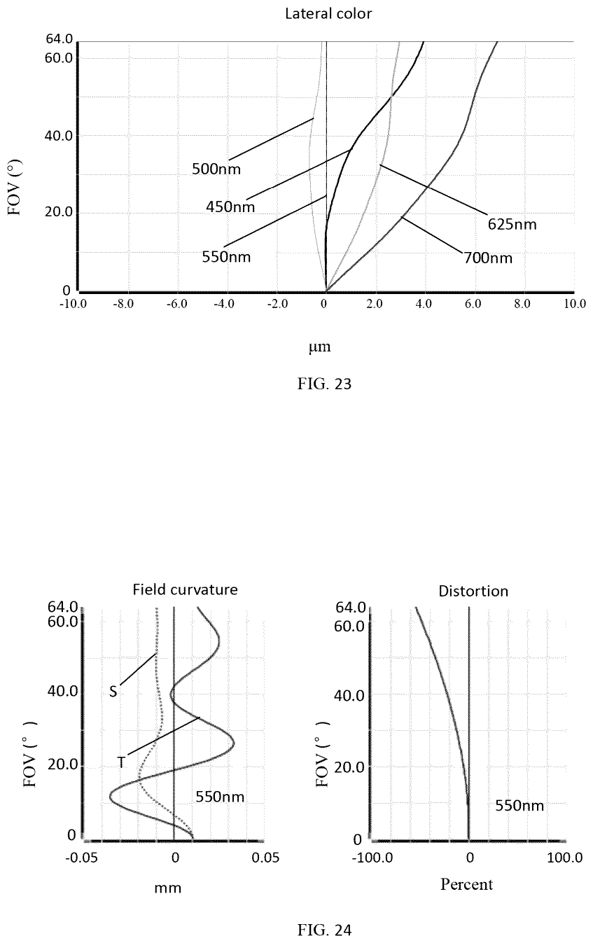

FIG. 22 and FIG. 23 respectively show the longitudinal aberration and lateral color schematic diagrams after light with wavelengths of 700 nm, 625 nm, 550 nm, 500 nm, and 450 nm passes through the camera optical lens 60 in the sixth embodiment. FIG. 24 shows the schematic diagrams of the field curvature and distortion after light with a wavelength of 550 nm passes through the camera optical lens 60 in the sixth embodiment. The field curvature S in FIG. 24 is a field curvature in the sagittal direction, and T is the field curvature in the meridian direction.

The Table 15 shows later lists the values of the corresponding conditions in this embodiment according to the above conditions. Obviously, the camera optical lens 60 of the embodiment satisfies the above conditions.

In this embodiment, the pupil entering diameter (ENPD) of the camera optical lens 60 is 2.445 mm, the image height (IH) of 1.0 H is 3.648 mm, and the field of view (FOV) in the diagonal direction is 128.00°. The camera optical lens 60 has good optical performance, and chromatic aberrations on-axis and chromatic aberrations off-axis are adequately corrected. And the camera optical lens 60 has excellent optical characteristics.

### Contrast Embodiment

The meaning of symbols in the contrast embodiment is basically the same as that in the first embodiment. Only the differences are listed below.

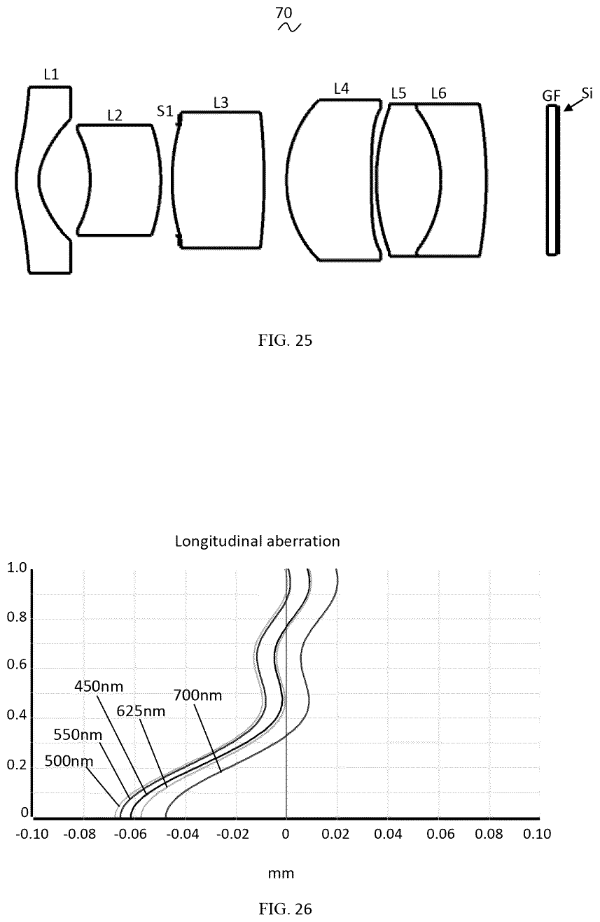

FIG. 25 shows the camera optical lens 70 in the contrast embodiment.

Table 13 shows the design data of the camera optical lens 70 in the contrast embodiment.

TABLE 13

| | R | d | | nd | | νd | |
|---|---|---|---|---|---|---|---|
| S1 | ∞ | d0= | −8.752 | | | | |
| R1 | 5.394 | d1= | 1.213 | nd1 | 1.7433 | ν1 | 49.34 |
| R2 | 2.513 | d2= | 2.766 | | | | |
| R3 | −5.517 | d3= | 3.800 | nd2 | 1.7015 | ν2 | 41.14 |
| R4 | −9.232 | d4= | 0.605 | | | | |
| R5 | 10.896 | d5= | 4.957 | nd3 | 1.5891 | ν3 | 61.25 |
| R6 | −33.773 | d6= | 1.216 | | | | |
| R7 | 6.281 | d7= | 4.579 | nd4 | 1.4970 | ν4 | 81.61 |
| R8 | 125.266 | d8= | 0.261 | | | | |
| R9 | 11.153 | d9= | 3.473 | nd5 | 1.5891 | ν5 | 61.25 |
| R10 | −6.283 | d10= | 0.000 | | | | |
| R11 | −6.283 | d11= | 2.442 | nd6 | 1.9460 | ν6 | 17.94 |
| R12 | −23.343 | d12= | 3.277 | | | | |
| R13 | ∞ | d13= | 0.500 | ndg | 1.5168 | νg | 64.17 |
| R14 | ∞ | d14= | 0.124 | | | | |

Table 14 shows aspherical surface data of the first lens L1 and the fourth lens L4 of the camera optical lens 70 in the contrast embodiment of the present disclosure.

TABLE 14

| | conic coefficients | Aspheric surface coefficients | | | | |
|---|---|---|---|---|---|---|
| | k | A4 | A6 | A8 | A10 | A12 |
| R1 | −1.32521E+00 | −5.59914E−03 | 5.94362E−05 | 2.34583E−05 | −2.13998E−06 | 9.07842E−08 |
| R2 | −1.02763E+00 | −9.79864E−03 | 1.97076E−03 | −6.41901E−04 | 1.45689E−04 | −1.84755E−05 |
| R7 | −2.19883E+00 | 6.39500E−04 | 1.56549E−04 | −2.67675E−05 | 2.71249E−06 | −1.53834E−07 |
| R8 | −3.27116E+02 | 1.39860E−03 | −1.01953E−05 | 8.60100E−06 | −1.22655E−06 | 1.04035E−07 |

| | |
|---|---|
| conic coefficients | Aspheric surface coefficients |

| | k | A14 | A16 |
|---|---|---|---|
| R1 | −1.32521E+00 | −1.94049E−09 | 1.63643E−11 |
| R2 | −1.02763E+00 | 1.22749E−06 | −3.31795E−08 |
| R7 | −2.19883E+00 | 4.58257E−09 | −5.51442E−11 |
| R8 | −3.27116E+02 | −4.30756E−09 | 7.97857E−11 |

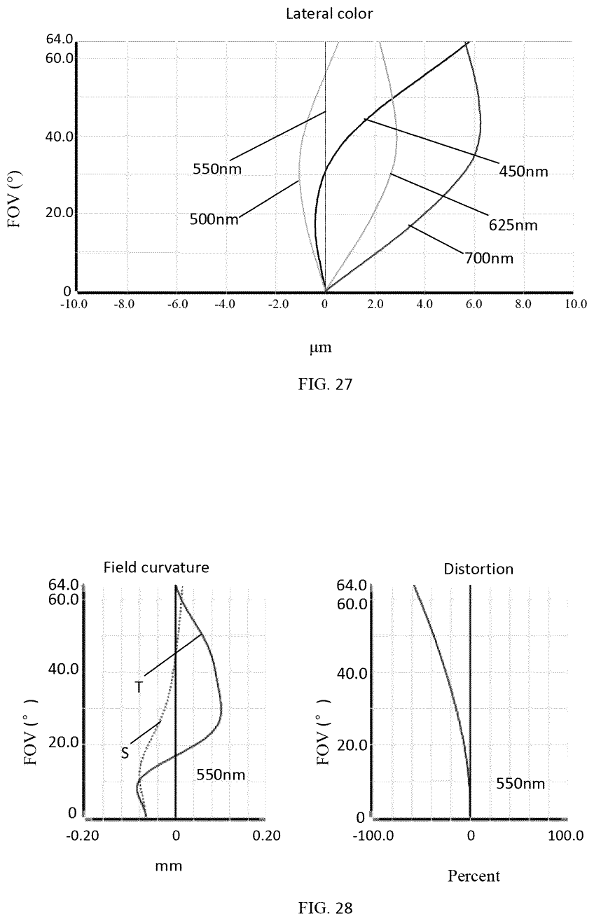

FIG. 26 and FIG. 27 respectively show the longitudinal aberration and lateral color schematic diagrams after light with wavelengths of 700 nm, 625 nm, 550 nm, 500 nm, and 450 nm passes through the camera optical lens 70 in the contrast embodiment. FIG. 28 shows the schematic diagrams of the field curvature and distortion after light with a wavelength of 550 nm passes through the camera optical lens 70 in the contrast embodiment. The field curvature S in FIG. 28 is a field curvature in the sagittal direction, and T is the field curvature in the meridian direction.

The Table 15 shows later lists the values of the corresponding conditions in this embodiment according to the above conditions.

In this embodiment, the pupil entering diameter (ENPD) of the camera optical lens 70 is 2.877 mm, the image height (IH) of 1.0 H is 4.003 mm, and the field of view (FOV) in the diagonal direction is 128.00°.

The Table 15 shows below lists the values of the corresponding conditions in the contrast embodiment according to the above conditions. Obviously, the camera optical lens 70 of the contrast embodiment does not satisfy the above condition, 0.10≤d2/TTL≤0.20 and cannot balance the field curvature of the system.

TABLE 15

| Parameters | | | | | | | |
|---|---|---|---|---|---|---|---|
| and | First | Second | Third | Fourth | Fifth | Sixth | Contrast |
| conditions | Embodiment | Embodiment | Embodiment | Embodiment | Embodiment | Embodiment | Embodiment |
| d2/TTL | 0.126 | 0.101 | 0.200 | 0.141 | 0.193 | 0.134 | 0.095 |
| f3/f4 | 1.082 | 1.394 | 0.608 | 1.093 | 1.121 | 1.051 | 1.109 |
| R7/R8 | 0.044 | 0.010 | 0.300 | 0.024 | 0.047 | 0.025 | 0.050 |
| f | 4.858 | 4.309 | 5.093 | 5.040 | 4.948 | 3.913 | 4.603 |
| f1 | −9.034 | −7.325 | −13.976 | −10.483 | −15.371 | −5.719 | −7.688 |
| f2 | −30.651 | −37.811 | −53.755 | −28.357 | −32.148 | −37.794 | −33.685 |
| f3 | 14.272 | 16.651 | 12.052 | 14.159 | 14.674 | 13.518 | 14.535 |
| f4 | 13.186 | 11.942 | 19.835 | 12.959 | 13.094 | 12.864 | 13.102 |
| f5 | 7.216 | 6.725 | 6.438 | 5.610 | 7.381 | 6.046 | 7.366 |
| f6 | −9.498 | −9.399 | −8.695 | −6.256 | −8.297 | −8.039 | −9.767 |
| FNO | 1.600 | 1.600 | 1.600 | 1.600 | 1.600 | 1.600 | 1.600 |
| TTL | 27.800 | 29.417 | 25.479 | 25.313 | 24.766 | 26.963 | 29.214 |

It can be understood by a person of ordinary skill in the art that the above embodiments are specific embodiments of the realization of the present disclosure, and that various changes can be made thereto in form and detail in practical application without departing from the spirit and scope of the present disclosure.

What is claimed is:

1. A camera optical lens, comprising, from an object side to an image side in sequence being:
a first lens having a negative refractive power;
a second lens having a negative refractive power;
a third lens having a positive refractive power;
a fourth lens having a positive refractive power;
a fifth lens having a positive refractive power;
a sixth lens having a negative refractive power;
wherein the camera lens satisfies the following conditions:
$$0.1 \leq d 2 / TTL \leq 0.2 ;$$
$$0.6 \leq f 3 / f 4 \leq 1.4 ;$$
$$0.01 \leq R 7 / R 8 \leq 0.3 ;$$
where,
d2 represents a distance on axis between an image side surface of the first lens and an object side surface of the second lens;
TTL represents a total track length of the camera optical lens;
f3 represents a focal length of the third lens;
f4 represents a focal length of the fourth lens;
R7 represents a central curvature radius of the object side surface of the fourth lens;
R8 represents a central curvature radius of the image side surface of the fourth lens.

2. The camera optical lens according to claim 1, wherein the camera optical lens further satisfies the following conditions:
$$1.8 \leq ( R 1 + R 2 ) / ( R 1 - R 2 ) \leq 6.3 ;$$
where,
R1 represents a central curvature radius of the object side surface of the first lens;
R2 represents a central curvature radius of the image side surface of the first lens.

3. The camera optical lens according to claim 1, wherein the fifth lens is provided glued to the sixth lens.

4. The camera optical lens according to claim 3, wherein the camera optical lens further satisfies the following conditions:
$$v 5 - v 6 \geq 35. ;$$
where,
v5 represents an abbe number of the fifth lens;
v6 represents an abbe number of the sixth lens.

5. The camera optical lens according to claim 1, wherein the camera optical lens further satisfies the following conditions:
$$v 5 - v 6 \geq 35. ;$$
where,
v5 represents an abbe number of the fifth lens;
v6 represents an abbe number of the sixth lens.

6. The camera optical lens according to claim 1, wherein the camera optical lens further satisfies the following conditions:
$$5. \leq TTL / f \leq 7. ;$$
where,
f represents a focal length of the camera optical lens.

7. The camera optical lens according to claim 1, wherein an object side surface of the first lens is convex in a paraxial region, an image side surface of the first lens is concave in a paraxial region; and the camera optical lens further satisfies the following conditions:
$$- 6.21 \leq f 1 / f \leq - 0.97 ;$$
$$0.01 \leq d 1 / TTL \leq 0.1 ;$$
where,
f1 represents a focal length of the first lens;
f1 represents a focal length of the first lens;
d1 represents a thickness on-axis of the first lens.

8. The camera optical lens according to claim 1, wherein an object side surface of the second lens is concave in a paraxial region, an image side surface of the second lens is convex in a paraxial region; and the camera optical lens further satisfies the following conditions:
$$- 21.11 \leq f 2 / f \leq - 3.75 ;$$
$$- 9.81 \leq ( R 3 - R 4 ) / ( R 3 - R 4 ) \leq - 2.45 ;$$
$$0.06 \leq d 3 / TTL \leq 0.26 ;$$
where,
f represents a focal length of the camera optical lens;
f2 represents a focal length of the second lens;
R3 represents a central curvature radius of the object side surface of the second lens;
R4 represents a central curvature radius of the image side surface of the second lens;
d3 represents a thickness on-axis of the second lens.

9. The camera optical lens according to claim 1, wherein an object side surface of the third lens is convex in a paraxial region, an image side surface of the third lens is convex in a paraxial region; and the camera optical lens further satisfies the following conditions:
$$1.18 \leq f 3 / f \leq 5.8 ;$$
$$- 1.96 \leq ( R 5 + R 6 ) / ( R 5 - R 6 ) \leq - 0.31 ;$$
$$0.02 \leq d 5 / TTL \leq 0.26 ;$$
where,
f represents a focal length of the camera optical lens;
R5 represents a central curvature radius of the object side surface of the third lens;
R6 represents a central curvature radius of the image side surface of the third lens;
d5 represents a thickness on-axis of the third lens.

10. The camera optical lens according to claim 1, wherein an object side surface of the fourth lens is convex in a paraxial region, an image side surface of the fourth lens is concave in a paraxial region; and the camera optical lens further satisfies the following conditions:
$$1.29 \leq f 4 / f \leq 5.84 ;$$
$$- 3.71 \leq ( R 7 + R 8 ) / ( R 7 - R 8 ) \leq - 0.68 ;$$
$$0.07 \leq d 7 / TTL \leq 0.26 ;$$
where,
f represents a focal length of the camera optical lens;
d7 represents a thickness on-axis of the fourth lens.

11. The camera optical lens according to claim 1, wherein an object side surface of the fifth lens is convex in a paraxial region, an image side surface of the fifth lens is convex in a paraxial region; and the camera optical lens further satisfies the following conditions:
$$0.56 \leq f 5 / f \leq 2.34 ;$$
$$0.13 \leq ( R 9 + R 10 ) / ( R 9 - R 10 ) \leq - 0.5 ;$$
$$0.05 \leq d 9 / TTL \leq 0.18 ;$$
where,
f represents a focal length of the camera optical lens;
f5 represents a focal length of the fifth lens;
R9 represents a central curvature radius of the object side surface of the fifth lens;
R10 represents a central curvature radius of the image side surface of the fifth lens;
d9 represents a thickness on-axis of the fifth lens.

12. The camera optical lens according to claim 1, wherein an object side surface of the sixth lens is concave in a paraxial region, an image side surface of the sixth lens is convex in a paraxial region; and the camera optical lens further satisfies the following conditions:
$$- 4.36 \leq f 6 / f \leq 0.83 ;$$
$$- 3.71 \leq ( R 11 + R 12 ) / ( R 11 - R 12 ) \leq - 0.72 ;$$
$$0.03 \leq d 11 / TTL \leq 0.13 ;$$
where,
f represents a focal length of the camera optical lens;
f6 represents a focal length of the sixth lens;
R11 represents a central curvature radius of the object side surface of the sixth lens;
R12 represents a central curvature radius of the image side surface of the sixth lens;
d11 represents a thickness on-axis of the sixth lens.

13. The camera optical lens according to claim 1, wherein the first lens is made of glass material; the second lens is made of glass material; the third lens is made of glass material; the fourth lens is made of glass material; the fifth lens is made of glass material; the sixth lens is made of glass material.
